(19) United States
(12) Patent Application Publication
(10) Pub. No.: US 2015/0303772 A1
(43) Pub. Date: Oct. 22, 2015

(54) Device For The Air-Cooling Of A Blower For A Heating, Ventilation Or Air-Conditioning Apparatus

(71) Applicant: VALEO SYSTEMS THERMIQUES, Le Mesnil Saint Denis (FR)

(72) Inventors: Morgan Le Goff, Epinay sur Orge (FR); Philippe Vincent, Epernon (FR); Bertrand Puzenat, Montigny le Bretonneux (FR)

(21) Appl. No.: 14/367,502

(22) PCT Filed: Dec. 17, 2012
(86) PCT No.: PCT/EP2012/075685

§ 371 Date: Jun. 20, 2014

(30) Foreign Application Priority Data
Dec. 23, 2011 (FR) 1104055

(51) Int. Cl. H02K 9/02; F04D 29/32; F04D 25/08; F04D 19/00; F04D 25/06

(52) U.S. Cl. CPC H02K 9/02; F04D 19/002; F04D 25/06; F04D 25/08; F04D 29/325

(57) ABSTRACT

Device (3) for the air-cooling of a blower for a heating, ventilation and/or air-conditioning apparatus comprising at least one cooling duct (4) comprising at least one cooling-air inlet (5) and defining a cooling-air-stream flow path (4′) that the cooling-air-stream is at least partially supposed to travel, the duct (4) being delimited by at least one wall, the cooling device (3) being characterized in that the cooling duct (4) comprises at least one cooling-air-stream distribution element (6) arranged in the flow path (4′) of the duct (4).

The present invention relates to the field of installations for ventilation, heating and/or air-conditioning of automobiles. The present invention relates more particularly to the system for cooling of the motor and of the control module of a blower.

A blower is understood to be an assembly comprising an electric motor intended to drive a turbine, a motor control module, a motor support which ensures the retention of the motor and of the control module and a cooling device for the motor and for the control module.

A blower unit is understood to be an assembly comprising a blower associated with a volute.

Generally, the air stream generated by the blower is taken preferably from the interior of the volute and is routed towards the drive motor in order to cool it. One or more cooling ducts routes the taken cooling-air-stream towards the driving motor of the blower, in particular closest to the heating zone, generally situated at the base of the motor in the region of the brushes. The cooling ducts are commonly shaped as ramps which favour the guidance of the cooling-air-stream towards the base of the motor, then towards the location of the motor control module.

Conventionally, the control module, which is often on the periphery of the motor support, is cooled by a mixture of a first cooling-air-stream coming directly from the volute and a second cooling-air-stream corresponding to the cooling-air-stream which has already cooled the motor. The mixture of streams then comes into contact with a heat sink integrated in the control module. The air stream mixture is slightly heated by the prior passage of the second cooling stream in the motor housing, which then gives rise to a less effective cooling of the module.

In a known manner, for simultaneous cooling of the motor and the control module, it has been proposed in certain prior art devices to dispose the motor and the control module in one and the same receiving housing, arranged in the motor support, in order that these two elements are swept simultaneously by the cooling-air-stream. The drawback of such a configuration is that since the motor gives off more heat than the control module, the cooling-air-stream is quickly heated by the heat emitted by the motor and loses cooling effectiveness over the other elements which require cooling.

Moreover, in this configuration, the cooling-air-stream is only guided towards the base of the housing accommodating the motor without any checking either of the flow rate or of the direction for example.

Another drawback of this configuration is that the air stream rushes into all of the housing thus exposing the electronic components of the control module to the humid cooling-air-stream.

The object of the present invention is to allow the controlled and effective cooling of the motor and of the control module of a blower, without comprising the compactness of said blower.

To this end, the present invention relates to a device for the aircooling of a blower for a heating, ventilation and/or airconditioning apparatus comprising at least one cooling duct comprising at least one cooling-air inlet and defining a cooling-air-stream flow path through which at least in part the cooling-air-stream is intended to travel. According to the present invention, the cooling duct of the cooling device comprises at least one cooling-air-stream distribution element (6) arranged on the flow path of the duct.

The present invention likewise relates to a motor support of a blower for heating, ventilation and/or air-conditioning apparatus, comprising a housing intended to receive at least a drive motor and a motor control module. According to the present invention, the housing for receiving the motor support also receives at least in part a cooling device according to the present invention.

The present invention likewise relates to a blower for heating, ventilation and/or air conditioning apparatus, comprising a drive motor, a motor control module, a motor support which may be in accordance with the invention. The blower according to the present invention comprises at least one cooling device according to the present invention.

According to one aspect of the invention, the cooling duct is delimited by at least one wall in which is arranged at least one cooling-air-stream distribution element, said at least one distribution element being an opening.

According to another aspect of the invention, the at least one cooling-air-stream distribution element is provided with at least one cooling-air-stream guide element.

According to another aspect of the invention, the at least one cooling duct comprises at least one cooling-air-stream deflection element.

According to another aspect of the invention, the cooling device comprises a cooling-air-stream inlet merged with the air stream inlet of the cooling duct.

According to another aspect of the invention, the cooling device comprises a substantially cylindrical ring in which the cooling duct is arranged.

According to another aspect of the invention, the cooling duct is disposed substantially concentrically with respect to the ring and to the axis of rotation of the motor.

According to another aspect of the invention, the at least one cooling duct comprises a plurality of cooling-air-stream distribution elements distributed irregularly along the flow path.

According to another aspect of the invention, the cooling duct comprises a plurality of cooling-air-stream distribution elements distributed at regular intervals along the flow path.

According to another aspect of the invention, a plurality of cooling-air-stream distribution elements have a different size of opening.

According to another aspect of the invention, a plurality of cooling-air-stream distribution elements have an identical size of opening.

According to another aspect of the invention, the cooling duct comprises at least one wall with a substantially flat internal surface.

According to another aspect of the invention, the cooling duct comprises at least one wall of which at least a part is formed by a succession of stepped surfaces.

The present invention will be better understood and other characteristics and advantages of the invention will become more apparent by reading the following detailed description comprising embodiments given by way of illustration with reference to the appended drawings, given by way of non-limiting examples, which may be used to add to the understanding of the present invention and the explanation of the implementation thereof and, as appropriate, to contribute to the definition thereof, on which:

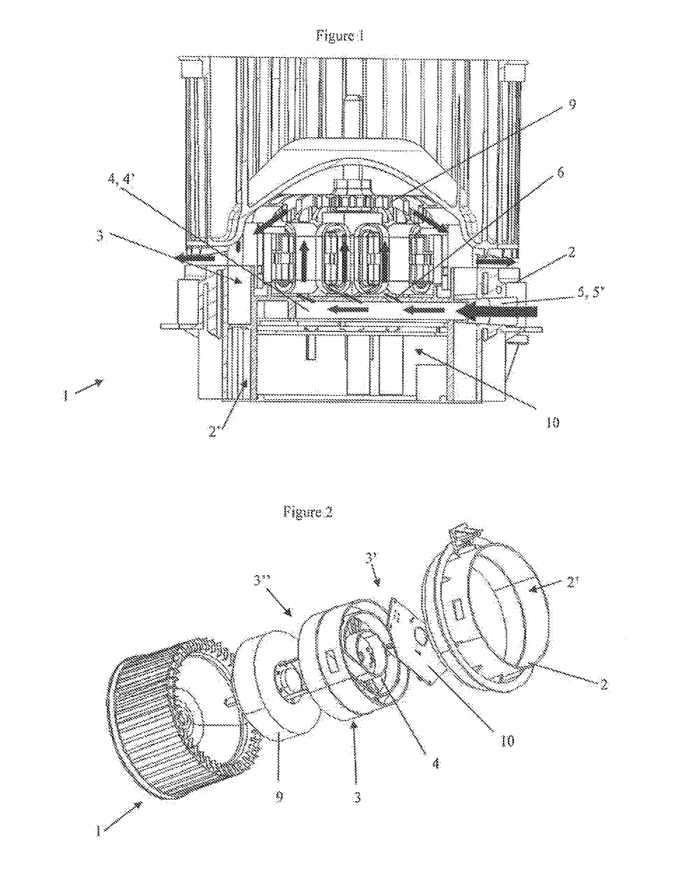

FIG. 1 shows a sectional view of a blower of a ventilation, heating and/or air conditioning installation comprising a cooling device according to the present invention,

FIG. 2 shows an exploded view of the blower illustrated in FIG. 1,

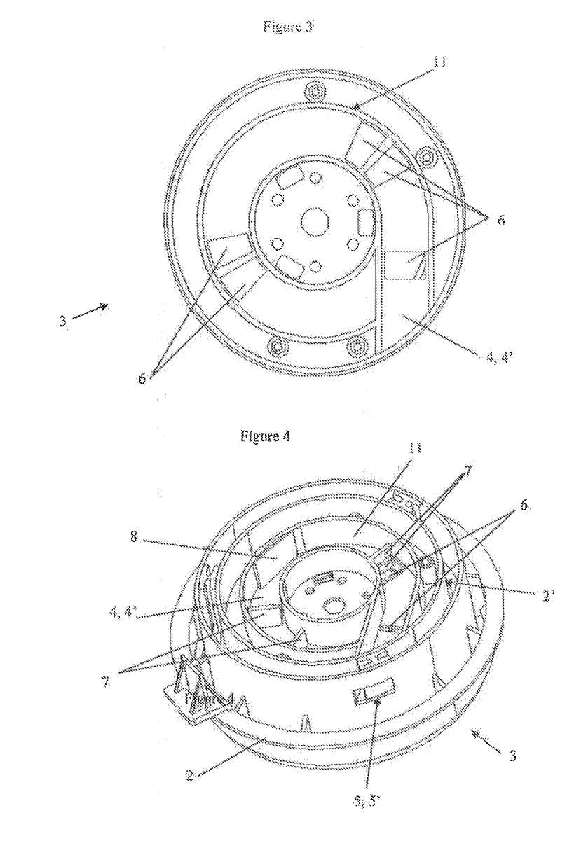

FIG. 3 shows a view from above of the cooling device of the present invention according to a first embodiment of the present invention,

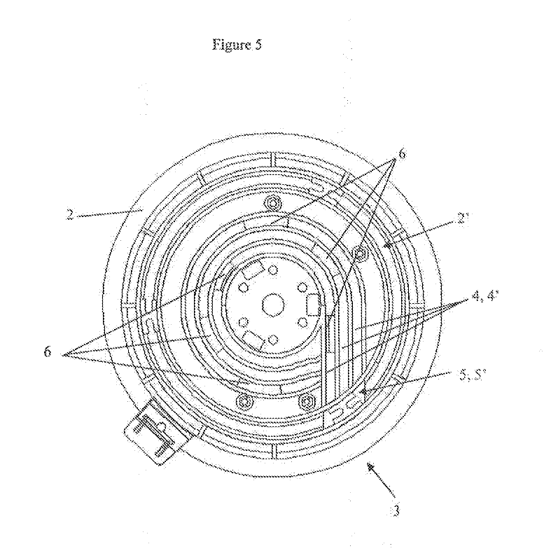

FIG. 4 shows a perspective view of a motor support comprising the cooling device of the present invention according to a second embodiment of the present invention, and

FIG. 5 shows a view from above of a motor support comprising the cooling device of the present invention according to a variant of the first embodiment shown in FIG. 3.

FIG. 1 shows a blower 1 for a heating, ventilation and/or air-conditioning apparatus, comprising at least one drive motor 9 of a turbine, a control module 10 of the motor 9, a motor support 2. The blower 1 also comprises a cooling device 3 as shown in FIGS. 1 to 5. This cooling device 3 allows the air-cooling of the motor 9 and of the control module 10 of the motor 9. The motor 9 and the control module 10 are received in a housing 2′ arranged in the motor support 2. The cooling device 3 is disposed at least in part in the housing 2′ of the motor support 2.

Preferably the cooling device 3 is disposed entirely in the housing 2′ of the motor support 2.

According to an aspect of the present invention, the cooling device 3 is disposed at least in part between the motor 9 and the control module 10 of the motor 9 so that the cooling-air-stream cools the control module 10 and the motor 9 successively and/or simultaneously. In fact, the cooling device 3 makes it possible to distribute a cooling-air-stream towards the control module 10 then/and towards the motor 9. Thus the cooling-air-stream flows over the surface of the control module 10 before reaching the lower end of the motor 9, so that the cooling-air-stream is cold when it passes over the control module 10, it is not heated by a prior passage towards the motor 9, thus improving the effectiveness of cooling of the air stream.

Preferably the cooling device 3 is disposed between the motor 9 and the control module 10 of the motor 9.

FIG. 2 shows an exploded view of the blower 1 which comprises the motor support 2 and the housing 2′ intended to receive at least the drive motor 9 and the control module 10 of the motor 9. The housing 2′ of the motor support 2 also receives at least in part the cooling device 3 as shown in FIGS. 1 to 5 according to the present invention.

According to an aspect of the present invention shown in FIG. 2, the drive motor 9 and the control module 10 of the motor 9 can be fixed on the cooling device 3. The motor 9 can be fixed by fixing means such as screws either on the front face 3′ or on the rear face 3″ of the cooling device 3. The control module 10 can be fixed by fixing means either on the front face 3′ when the motor 9 is fixed on the rear face 3″ or on the rear face 3″ when the motor is fixed on the front face 3′ of the cooling device 3. Such an arrangement makes it possible to isolate the control module 10 from the motor 9 and to ensure that the control module benefits from a cooling-air-stream which is cooler and therefore more efficient in its cooling than if the control module 10 were on one and the same face of the cooling device 2 as the motor 9.

This arrangement allows more efficient control and a better distribution of the cooling air stream when the control module 10 and the motor 9 are facing one another, both turned towards the cooling duct 4 of the cooling device 3.

Advantageously and as FIG. 2 shows, the cooling device 3 comprises a receiving surface arranged on its front face 3′ and rear face 3″. The receiving surface makes it possible to accommodate the motor 9 on one of its faces 3′ and the control module 10 on the other face 3″. The receiving surface comprises orifices allowing connectors of the motor to pass through to the control module. It is also possible to provide fixing means on the periphery of the cooling duct 4 allowing the fixing of the control means 10.

According to an aspect of the invention, the motor support 2 as shown in FIGS. 1, 2, 4 and 5 can be implemented in one piece with the at least one cooling device 3, which makes it possible to reduce the manufacturing costs.

As shown in FIGS. 1 to 5 and more particularly in FIGS. 3 to 5, the present invention relates to a device 3 for the air-cooling of the blower for a heating, ventilation and/or air-conditioning apparatus comprising at least one cooling duct 4 comprising at least one cooling-air inlet 5 and defining a cooling-air-stream flow path 4′ through which at least in part the cooling-air-stream is intended to travel, the duct 4 being delimited by at least one wall 11. The cooling duct 4 comprises at least one cooling-air-stream distribution element 6 arranged on the flow path 4′ of the duct 4. The distribution element 6 of the cooling-air-stream is an element which makes it possible to control the cooling of the motor 9 and of the control module 10 by distributing the cooling-air-stream from the flow path 4′ towards the components of said motor 9 and control module 10 which need to be cooled.

According to an aspect of the present invention and as shown in particular in FIG. 3, the cooling duct 4 is delimited by at least one wall 11 in which at least one cooling-air-stream distribution element is arranged, said at least one distribution element 6 being an opening 6 passing through said wall 11 of the duct 4. This aspect has the advantage of allowing the air stream, passing through the opening 6, to cool the motor 9 and the control module 10 which are each arranged on one side of the wall 11 respectively on the front face 3′ and rear face 3″ or vice versa as shown in FIGS. 1 and 2.

According to an aspect of the present invention and a first embodiment of the cooling device 3 shown in FIG. 3, the cooling device comprises a plurality of cooling-air-stream distribution elements 6 arranged on the flow path 4′ of the duct 4.

Advantageously these distribution elements 6 are similar to cooling-air-stream outlets. The cooling-air-stream distribution elements 6 according to the present invention are arranged on the flow path 4′ of the duct 4 in such a way that the cooling-air-stream is distributed towards the motor 9 and the control module 10 in order to cool them substantially at the same time.

Preferably, the openings of the cooling-air-stream distribution elements 6 are included in one and the same plane substantially perpendicular to the axis of the motor.

FIG. 4 shows a second embodiment of a cooling device 3 according to the present invention, wherein the cooling-air-stream distribution element 6 is equipped with at least one cooling-air-stream guide element 7. This guide element 7 is arranged in a plane substantially perpendicular to the plane which includes the openings 6.

According to a variant (not shown) the guide element 7 is inclined so that the angle which it forms with the plane in which the openings 6 are provided is an angle different from 0°.

The openings of the cooling-air-stream distribution element 6 are delimited by at least one edge close to which at least one guide element 7 can be advantageously disposed.

According to an aspect of the present invention, the guide element 7 may be a slope or a gradient which makes it possible to guide the cooling-air-stream towards the air stream distribution element.

According to another aspect of the present invention this guide element may be disposed either on the front face 3′ of the cooling device 3 and/or on the rear face 3″. The cooling-air-stream guide element 7 may extend beyond both sides of the opening 6 so that these ends project on both sides of the wall 11 of the cooling duct 4.

Preferably, each cooling stream guide element 7 has an appropriate inclination depending on the cooling-air-stream to be transmitted to the components to be cooled. In fact, if a component of the control module 10 or of the motor 9 generates substantial heat and needs more cooling than other components, by means of these cooling-air-stream guide elements 7, the cooling-air-stream can be guided more efficiently towards said component by giving it a priority generated by the guide element 7 depending on its inclination for example. A priority can also be generated as a function of parameters relating to the guide element 7 such as the height or the arrangement thereof with respect to the distribution element 6 for example.

Alternatively, each cooling stream guide element 7 has an identical inclination.

According to an aspect of the present invention, the cooling-air-stream guide element 7 likewise has the function of closing the access at least in part to certain cooling-air-stream distribution elements 6 in such a way that a regulation of the flow rate of the cooling-air-stream takes place in the region of the openings 6 of the distribution elements 6.

According to an aspect of the present invention, the cooling duct 4 comprises at least one cooling-air-stream deflection element 8. The cooling-air-stream deflection element 8 is arranged in the cooling duct 4 in such a way as to modify the direction of the cooling stream on the cooling path 4′ which has the advantage of substantially accelerating the speed of the cooling-air-stream and directing this latter towards the guide elements 7 and/or the cooling-air-stream distribution elements 6.

According to an aspect of the invention illustrated in FIGS. 1 to 5, the cooling device 3 comprises a substantially cylindrical ring in which the cooling duct 4 is arranged.

According to another aspect of the present invention, the cooling stream guide element or elements 7 can be formed in one piece with the cooling device 3.

The same applies to the cooling stream deflection element or elements 8 which can likewise be produced in one piece with the cooling device 3.

Advantageously the ring is of substantially cylindrical shape, which allows the adaptation of the cooling device 3 to a conventional motor support which generally comprises the housing of substantially cylindrical shape and which consequently can correctly receive the cooling device 3 according to the present invention.

Therefore by means of this configuration and according to the present invention the cooling duct 4 can be disposed substantially concentrically with respect to the ring and to the axis of rotation of the motor. It may take the form of a spiral with one or more turns, in other words with one or more ducts 4.

Moreover, the cooling duct 4 comprises a cooling stream inlet 5′ merged with the air stream inlet 5 of the cooling device 3 as shown in FIGS. 1, 4 and 5. The cooling duct 4 also comprises an end which can be closed or in which a cooling-air-stream distribution element 6 is arranged.

According to an aspect of the invention shown in FIGS. 3 to 5, the cooling duct comprises a plurality of cooling-air-stream distribution elements 6 distributed irregularly along the flow path 4′. Alternatively, the cooling duct 4 comprises a plurality of cooling-air-stream distribution elements 6 distributed at regular intervals along the flow path 4′. The distribution of the cooling-air-stream distribution elements 6 may be a function of the distribution of the components to be cooled regardless of whether they belong to the motor 9 or to the control module 10.

According to an aspect of the invention likewise shown in FIGS. 3 to 5, the cooling duct 4 comprises a plurality of cooling-air-stream distribution elements 6 which have a different size of opening 6. Alternatively, the cooling duct 4 comprises a plurality of cooling-air-stream distribution elements 6 which have an identical size of opening 6. The size of the opening 6 of the distribution elements 6 may be adapted as a function of the heating of the components which said distribution elements 6 serve, in such a way that a component which becomes very hot will be swept by a cooling-air-stream distributed through a larger opening 6.

Advantageously, the opening 6 of each cooling-air-stream distribution elements 6 occupies the entire width of the cooling duct 4.

Alternatively, the opening 6 occupies part of the width of the cooling duct 4.

According to an aspect of the present invention, the cooling duct comprises at least one wall with a substantially flat internal surface. The wall 11 of the cooling duct 4 is substantially U-shaped. The wall 11 delimits said cooling duct 4. The internal surface of this wall 11 is the surface in contact with the cooling-air-stream. The wall 11 preferably has a flat surface. Advantageously, the wall 11 comprises at least one base surface which may be flat.

According to another aspect of the present invention (not shown), the cooling duct comprises at least one wall of which at least one part is formed by a succession of stepped surfaces. Advantageously, the wall 11 comprises at least one base surface which may be formed by a succession of stepped surfaces. The surfaces being connected to one another by risers in which at least one cooling-air-stream distribution element 6 is arranged.

FIG. 5 shows a variant of the first embodiment shown in FIG. 3, wherein the cooling device 3 comprises a plurality of cooling ducts 4 or spirals in which a plurality of cooling air stream distribution elements 6 are arranged.

One of the advantages of this cooling device 3 is the fact that the cooling of the motor 9 and of the control module 10 takes place whilst preserving the compactness of the blower assembly since the cooling device 3 is received directly in the housing 2′ of the motor support 2. Moreover, according to an aspect of the invention the motor 9 may be of the brushless type so that the compactness of the assembly is improved.

Clearly, the invention is not limited to the embodiments described above and given solely by way of example. It comprises various modifications, alternative forms and other variants which a person skilled in the art may envisage within the scope of the present invention and in particular all combinations of the different modes of operation described previously, which may be taken separately or together.

1. A cooling device (3) for an air-cooling of a blower for a heating, ventilation and/or air-conditioning apparatus, the device (3) comprising:
at least one cooling duct (4) comprising at least one cooling-air inlet (5) and defining a cooling-air-stream flow path (4′) through which at least in part the cooling-air-stream is intended to travel,
wherein the cooling duct (4) comprises at least one cooling-air-stream distribution element (6) arranged in the flow path (4′) of the duct (4).

2. A cooling device according to claim 1, wherein the cooling duct (4) is delimited by at least one wall (11) with the at least one cooling-air-stream distribution element (6) defined by the at least one wall (11), with the at least one distribution element (6) being an opening (6).

3. A cooling device according to claim 1, wherein the at least one cooling-air-stream distribution element (6) is provided with at least one cooling-air-stream guide element (7).

4. A cooling device according to claim 1, wherein the at least one cooling duct (4) comprises at least one cooling-air-stream guide element (8).

5. A cooling device according to claim 1, wherein the inlet (5) of the cooling-air-stream of the cooling device (3) is merged at least in part with an inlet (5′) of the air stream of the cooling duct (4).

6. A cooling device according to claim 1, further comprising a substantially cylindrical ring in which the cooling duct (4) is arranged.

7. A cooling device according to claim 6, wherein the cooling duct (4) is disposed substantially concentrically with respect to the ring and to an axis of rotation of a motor (9).

8. A cooling device according to claim 1, wherein the at least one cooling duct (4) comprises a plurality of cooling-air-stream guide elements (6) distributed irregularly along the flow path (4′).

9. A cooling device according to claim 1, wherein the cooling duct (4) comprises a plurality of cooling-air-stream distribution elements (6) distributed at regular intervals along the flow path (4′).

10. A cooling device according to claim 2, further comprising a plurality of cooling-air-stream distribution elements (6) have a different size of opening.

11. A cooling device according to claim 1, wherein the cooling duct (4) comprises at least one wall (11) having a substantially flat internal surface.

12. A cooling device according to claim 1, wherein the cooling duct (4) comprises at least one wall (11) having at least one part formed by a succession of stepped surfaces.

13. A motor support (2) of a blower (1) for a heating, ventilation and/or air-conditioning apparatus, the motor support (2) comprising a housing (2′) intended to receive:
at least one drive motor (9);
a control module (10) of the motor (9);
wherein the housing (2′) of the motor support (2) also receives at least in part a cooling device (3) according to claim 1.

14. A motor support (2) according to claim 13, wherein the cooling device (3) is disposed at least in part between the drive motor (9) and the control module (10).

15. A motor support according to claim 13, wherein the motor support (2) is implemented in one piece.

16. A blower (1) for a heating, ventilation and/or air conditioning apparatus, the blower comprising at least:
a motor (9) for driving a turbine;
a control module (10) of the motor (9); and
at least one cooling device (3) according to claim 1.

17. A blower (1) for a heating, ventilation and/or air-conditioning apparatus, the blower comprising at least:
a motor (9) for driving a turbine;
a control module (10) of the motor (9); and
a motor support (2) according claim 13.

18. A device according to claim 2, further comprising a plurality of cooling air stream distribution elements (6) have an identical size of opening.
